(19) United States
(12) Patent Application Publication
(10) Pub. No.: US 2011/0100764 A1
(43) Pub. Date: May 5, 2011

(54) Brake device and brake system using the same

(76) Inventor: Ming-Tse Hung, Taipei County (TW)

(21) Appl. No.: 12/926,167

(22) Filed: Oct. 29, 2010

(30) Foreign Application Priority Data
Nov. 2, 2009 (TW) 098137129

(51) Int. Cl. B62L 3/08; B62L 1/02

(52) U.S. Cl. 188/24.22

(57) ABSTRACT

A brake device and a brake system using the same are provided. The brake device mainly has a housing having one end oppositely connected to a top lid. A synchronization assembly accommodated with the housing has first and second end surfaces, through which active and passive brake cable sets penetrate. An active limiter is connected to the second end surface of the active brake cable set, and the passive brake cable set is connected to at least one passive limiter, at least one elastic member and at least one brake assembly. A rear wheel is firstly braked and then a front wheel is braked according to a ratio between the corresponding elastic members through the movements of the active and passive brake cable sets, the elastic member and the single synchronization assembly. Meanwhile, the overall size and the manufacturing cost of the brake device can be effectively and saved, respectively.

### BACKGROUND OF THE INVENTION

(1) Field of the Invention

The invention relates to a brake device and a brake system using the same, and more particularly to a brake device capable of effectively enhancing the brake security, reducing the size, saving the manufacturing cost, linking-up front and rear brakes and adjusting the brake ratios of the front and rear brakes, and a brake system using the same.

(2) Description of the Prior Art

At present, the typical brake structure is mainly implemented using a single-sided brake handle in conjunction with a single brake, wherein a brake cable is provided to connect the brake handle to the corresponding brake. For example, the left-side brake handle is connected to the brake of the rear wheel through one brake cable, while the right-side brake handle is connected to the brake of the front wheel through another brake cable. In addition, the brakes are fixedly disposed on the bicycle. Because the operators may have different operation practices, the consistent disposing method is not suitable for all the users.

In another brake structure, a single brake handle is connected the brake of the front wheel and the brake of the rear wheel through two brake cables so that the manipulator can manipulate the single brake handle to lock the brakes. Thus, the front wheel and the rear wheel tend to be instantaneously locked, and the manipulator may be hurt. So, the security thereof encounters the significant problem.

First, the coefficient of security is low. Second, the braking cannot be performed according to the predetermined ratio. Third, the large assembled size is required.

### SUMMARY OF THE INVENTION

To overcome the prior art drawbacks, a main object of the invention is to provide a brake device for firstly braking the rear wheel and then the front wheel when the brakes are synchronously enabled, and a brake system using the brake device.

Another object of the invention is to provide a brake device capable of dispersing the braking forces according to a predetermined ratio, and a brake system using the brake device.

Still another object of the invention is to provide a brake device with the effectively reduced size, and a brake system using the brake device.

Yet still another object of the invention is to provide a brake device capable of effectively enhancing the security, and a brake system using the brake system.

To achieve the above-identified objects, the invention provides a brake device mainly including a housing, a top lid and a synchronization assembly. The housing has an open end, a closed end and a chamber. The open end communicates with the chamber and is connected to the top lid. Each of the top lid and the closed end has at least one opening. The synchronization assembly is accommodated within the chamber. The synchronization assembly has a first end surface, a second end surface, and at least one first through hole and at least one second through hole formed between the first end surface and the second end surface. At least one active brake cable set is disposed in the first through hole and the opening of the top lid. The active brake cable set has at least one active brake cable penetrating through the opening of the top lid and the first through hole. A passive brake cable set is disposed in the second through hole and the opening of the closed end. The passive brake cable set has first and second passive brake cables, which respectively penetrate through the opening of the closed end and the second through hole. First and second elastic members are disposed at positions of the first end surface and connected to the first and second passive brake cables. Distal end positions of the first and second passive brake cables respectively penetrating through the second through hole are connected to first and second passive limiters.

To achieve the above-identified objects, the invention further provides a brake system including a brake device, a first brake assembly and a second brake assembly. The brake device has a housing. The housing has an open end, a closed end and a chamber. The open end communicates with the chamber. A top lid is disposed at the open end. Each of the top lid and the closed end has at least one opening. A synchronization assembly is disposed within the chamber. The synchronization assembly has a first end surface, a second end surface and at least one first through hole and at least one second through hole formed between the first end surface and the second end surface. An active brake cable set has at least one active brake cable penetrating through the opening of the top lid and the first through hole. A passive brake cable set has first and second passive brake cables, which respectively penetrate the opening of the closed end and the second through hole. The first brake assembly has a first elastic member and a first fixture limiter. The first elastic member and the first fixture limiter are connected to a distal end of a first passive brake cable. The second brake assembly has a second elastic member and a second fixture limiter. The second elastic member and the second fixture limiter are connected to the distal end of the second passive brake cable.

To achieve the above-identified objects, the invention additionally provides a brake system including a brake device, a first brake assembly and a second brake assembly. The brake device has a housing. The housing has an open end, a closed end and a chamber. The open end communicates with the chamber. A top lid is disposed at the open end. Each of the top lid and the closed end has at least one opening. A synchronization assembly is disposed within the chamber and has a first end surface, a second end surface, and at least one first through hole and at least one second through hole formed between the first end surface and the second end surface. An active brake cable set has at least one active brake cable penetrating through the opening of the top lid and the first through hole. A passive brake cable set has first and second passive brake cables, which respectively penetrate through the opening of the closed end and the second through hole and are respectively connected to the first brake assembly and the second brake assembly. When a first elastic member is disposed at the position of the first end surface and at the position of the first passive brake cable, the second brake assembly is provided with a second elastic member and a second fixture limiter, which are connected to a distal end of the second passive brake cable. In contract, when the second elastic member is disposed at the position of the second passive brake cable and the position of the first end surface, the first brake assembly is provided with a first elastic member and a first fixture limiter, which are connected to the distal end of the first passive brake cable.

The front and rear wheels may be braked through the movements of the active brake cable, the passive brake cable, the elastic member and the synchronization assembly, and the rear wheel may be firstly braked and then the front wheel is braked according to the ratio between the elastic members. Meanwhile, the overall size of the brake device can be effectively reduced, and the manufacturing cost of the brake device can be effectively saved.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorially exploded view showing a brake device of the invention.

FIG. 2 is a pictorially assembled view showing the brake device of the invention.

FIG. 3 is a schematically cross-sectional view showing the brake device of the invention.

FIG. 4 is a schematically cross-sectional view showing the brake device of the invention at another angle.

FIG. 5 is a first schematically cross-sectional operation view showing the brake device of the invention.

FIG. 6 is a first schematically cross-sectional operation view showing the brake device of the invention at another angle.

FIG. 7 is a second schematically cross-sectional operation view showing the brake device of the invention.

FIG. 8 is a second schematically cross-sectional operation view showing the brake device of the invention at another angle.

FIG. 9 is a schematic illustration showing the implementation of the brake system of the invention.

FIG. 10 is a schematic illustration showing another implementation of the brake assembly of the invention.

FIG. 11 is a schematic illustration showing another brake assembly of the invention at another angle.

FIG. 12 is a schematic illustration showing still another implementation of the brake device of the invention.

### DETAILED DESCRIPTION OF THE PREFERRED EMBODIMENTS

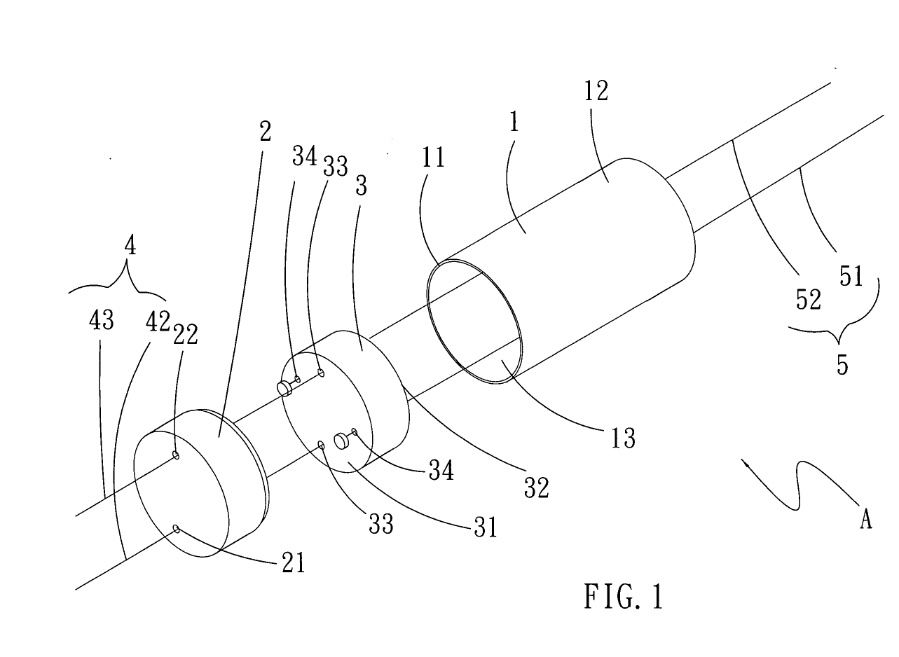

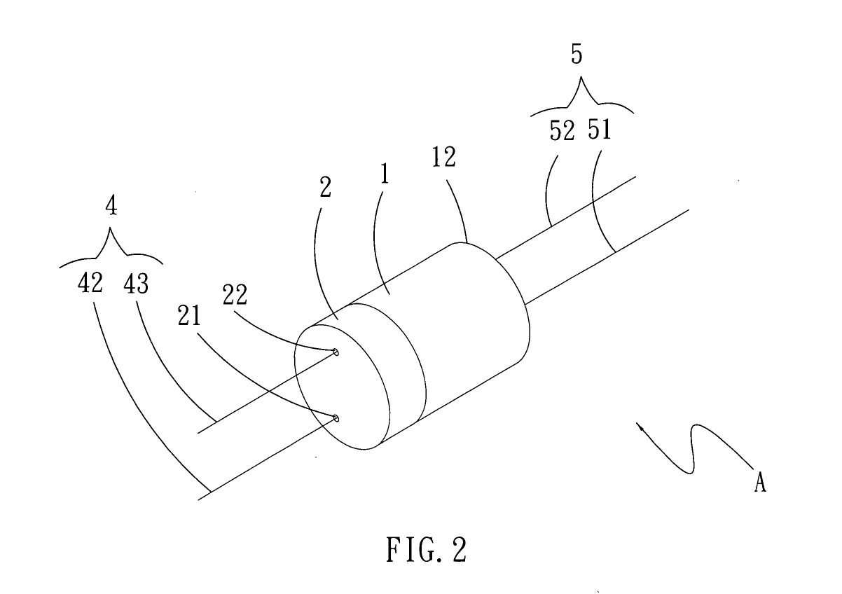

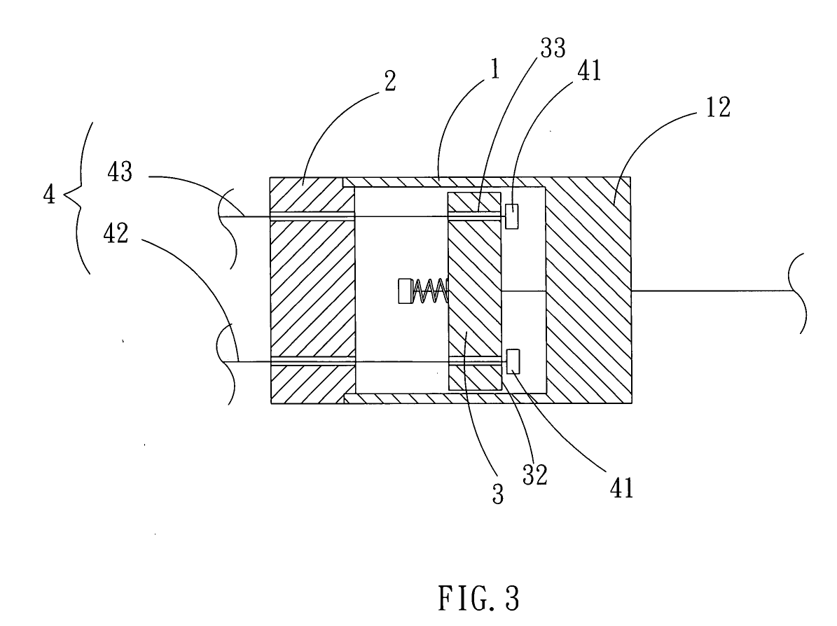

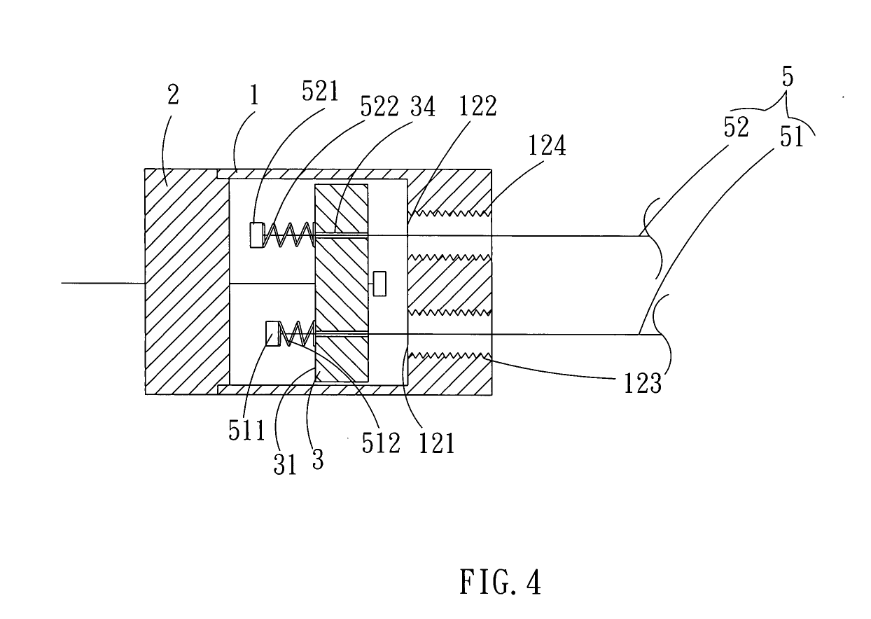

Referring to FIGS. 1, 2, 3 and 4, a brake device A of the invention includes a housing 1, a top lid 2 and a synchronization assembly 3. Two ends of the housing 1 respectively have an open end 11 and a closed end 12. The open end 11 is oppositely connected to the top lid 2. The top lid 2 has at least one opening. In this embodiment, a first opening 21 and a second opening 22 are formed on the top lid 2. The first opening 21 and the second opening 22 axially penetrate through the top lid 2, and the closed end 12 has a third opening 121 and a fourth opening 122, which axially penetrate through the closed end 12. The closed end 12 further has a first adjusting portion 123 and a second adjusting portion 124. The first adjusting portion 123 has a first internal thread hole communicating with the third opening 121. The second adjusting portion 124 has a second internal thread hole communicating with the fourth opening 122. Also, the housing 1 has a chamber 13 communicating with the open end 11.

The synchronization assembly 3 accommodated within the chamber 13 has a first end surface 31 and a second end surface 32. At least one first through hole 33 and at least one second through hole 34 are formed between the first end surface 31 and the second end surface 32. The first through hole 33 and the second through hole 34 axially penetrate through the synchronization assembly 3, and at least one active brake cable set 4 is disposed in the first through hole 33 and the first opening 21 and the second opening 22 of the top lid 2. The active brake cable set 4 penetrates through the first opening 21 and the second opening 22 of the top lid 2 and the first through hole 33. The distal end position of the active brake cable set 4 penetrating through the first through hole 33 is connected to an active limiter 41. The active limiter 41 corresponds to the position of the second end surface 32 of the synchronization assembly 3. In addition, a passive brake cable set 5 is disposed at the positions of the second through hole 34 and the third opening 121 and the fourth opening 122 of the closed end 12. The passive brake cable set 5 has a first passive brake cable 51 and a second passive brake cable 52. The first passive brake cable 51 penetrates through the third opening 121 and the second through hole 34. The distal end position of the first passive brake cable 51 penetrating through the second through hole 34 is connected to a first passive limiter 511. A first elastic member 512 is disposed between the first passive limiter 511 and the first end surface 31 of the synchronization assembly 3. The second passive brake cable 52 penetrates through the fourth opening 122 and the second through hole 34. The distal end position of the second passive brake cable 52 penetrating through the second through hole 34 is connected to a second passive limiter 521. A second elastic member 522 is disposed between the second passive limiter 521 and the first end surface 31 of the synchronization assembly 3.

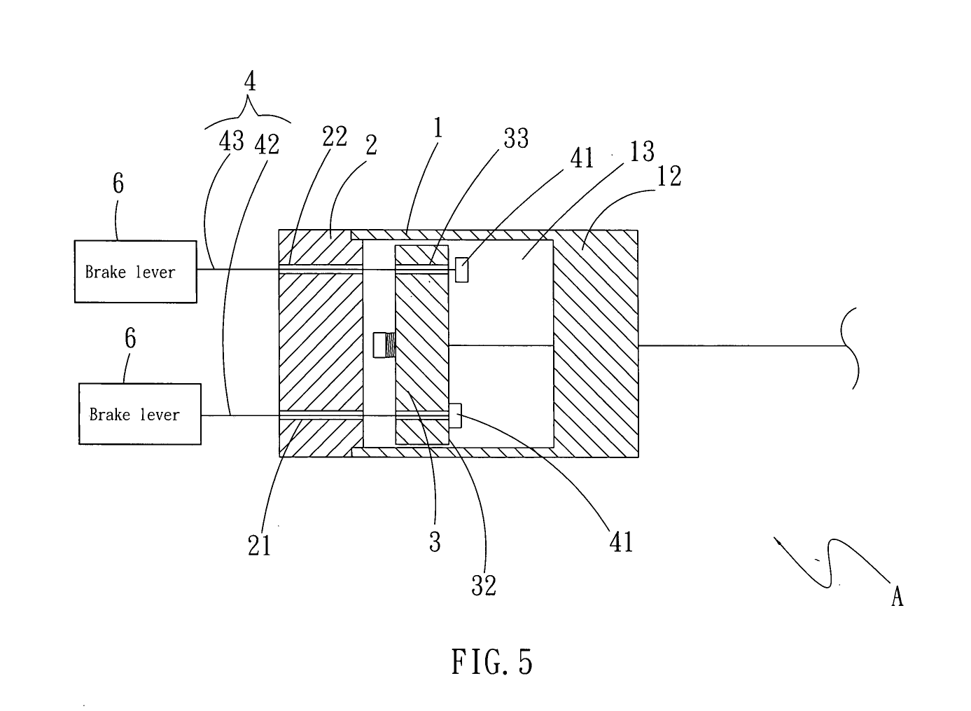

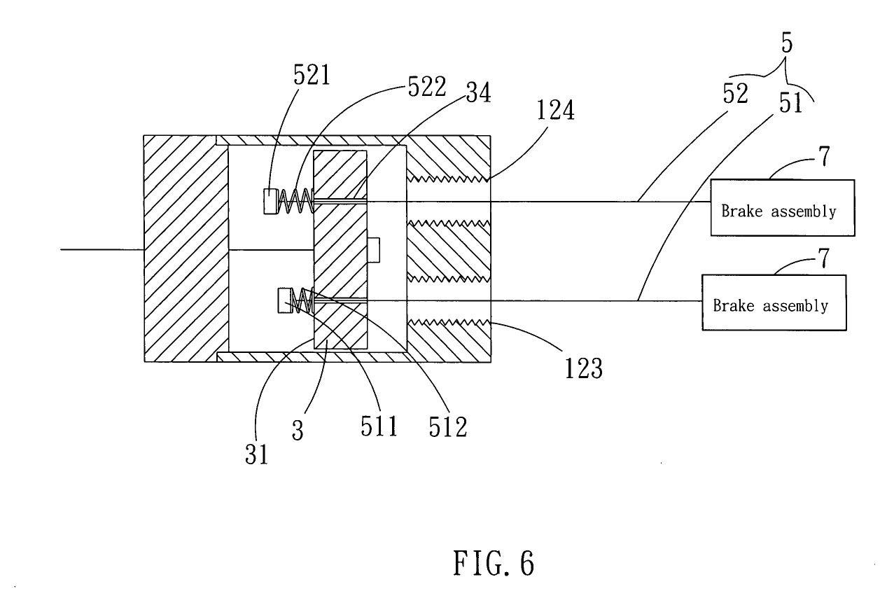

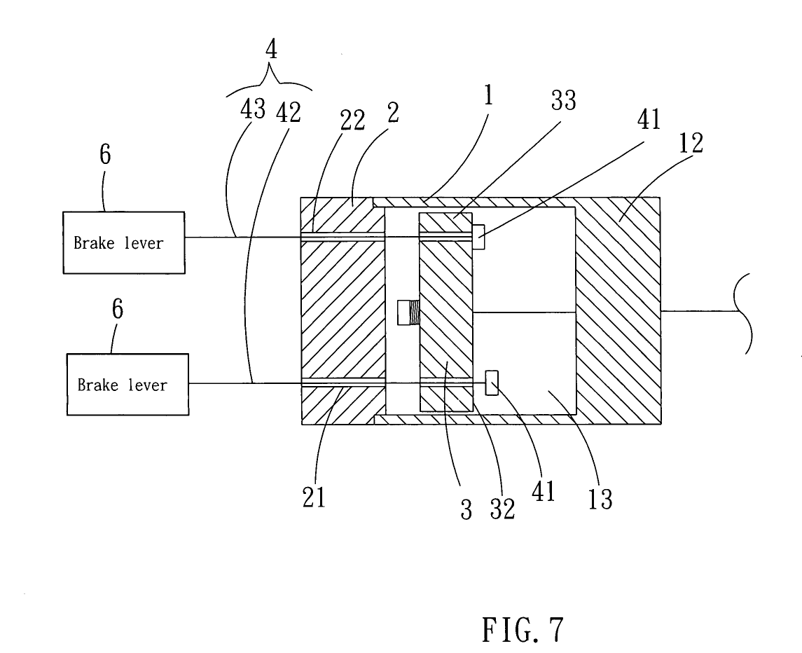

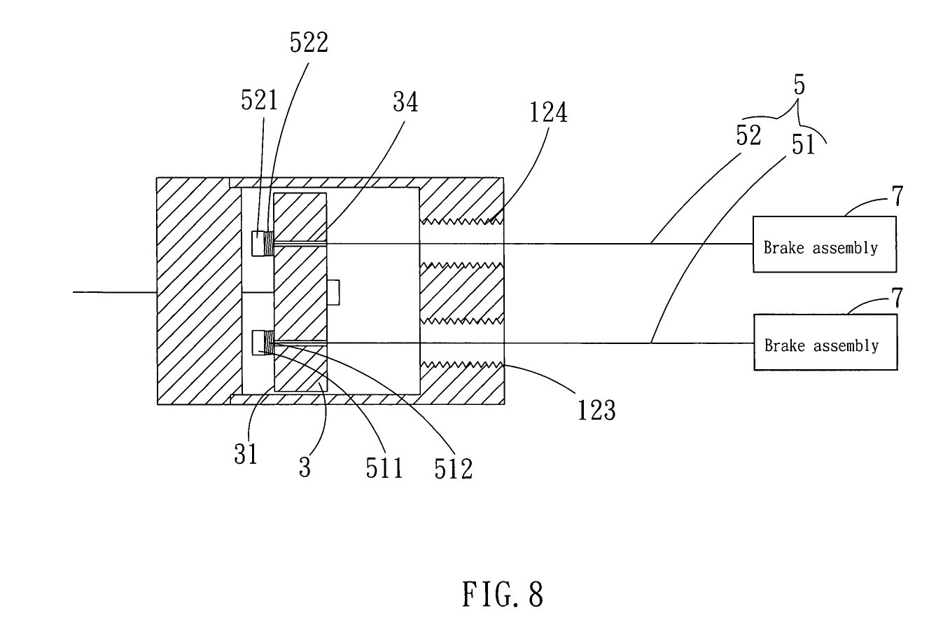

As shown in FIGS. 5, 6, 7 and 8, the active brake cable set 4 according to the preferred embodiment of the invention is connected to at least one brake lever 6, and the first passive brake cable 51 and the second passive brake cable 52 of the passive brake cable set 5 may be connected to at least one brake assembly 7. In this embodiment, the active brake cable set 4 includes a first active brake cable 42 and a second active brake cable 43. The first active brake cable 42 is connected to the brake lever 6 on the left side of the bicycle, the second active brake cable 43 is connected to the brake lever 6 on the right side of the bicycle, the first passive brake cable 51 is connected to the brake assembly 7 on the front wheel of the bicycle, and the second passive brake cable 52 is connected to the brake assembly 7 on the rear wheel of the bicycle.

When the left-side brake lever 6 is forced by the manipulator, the left-side brake lever 6 pulls the first active brake cable 42 to move the first active brake cable 42 in the first opening 21 and the first through hole 33, and to make the active limiter 41 on its one end attach to the second end surface 32, so that the synchronization assembly 3 is moved in the chamber 13. On the contrary, when the right-side brake lever 6 is forced by the manipulator, the right-side brake lever 6 pulls the second active brake cable 43 to move the second active brake cable 43 in the second opening 22 and the first through hole 33, and to make the active limiter 41 on its one end attach to the second end surface 32, so that the synchronization assembly 3 is moved in the chamber 13. Thus, when the manipulator manipulates either the left-side brake lever 6 or the right-side brake lever 6, the synchronization assembly 3 can be moved.

The movement of the synchronization assembly 3 simultaneously pulls the first passive brake cable 51 and the second passive brake cable 52 to concurrently operate the brake assembly 7 of the front wheel and the brake assembly 7 of the rear wheel. The synchronization assembly 3 simultaneously presses the first elastic member 512 and the second elastic member 522 on the first end surface 31. The first passive limiter 511 and the second passive limiter 521 restrict the positions of the first elastic member 512 and the second elastic member 522 and the length of the first elastic member 512 is selected to be shorter than the length of the second elastic member 522. So, when the first active brake cable 42 is forced to move the synchronization assembly 3, the synchronization assembly 3 pulls the first passive brake cable 51 and the second passive brake cable 52 concurrently. However, the applied force makes the synchronization assembly 3 firstly press the second elastic member 522, and the second passive brake cable 52 connected to the second elastic member 522 and the second passive limiter 521 are moved, owing to the synchronization assembly 3, to firstly pull the brake assembly 7 of the rear wheel connected to the second passive brake cable 52. Similarly, the first elastic member 512 may be selected to have the short length but the pounds more than those of the second elastic member 522. The brake assembly 7 of the rear wheel can be firstly braked and then the brake assembly 7 of the front wheel can be braked according to the predetermined ratio between the first elastic member 512 and the second elastic member 522 so that the brake security can be achieved. Thus, in this embodiment, the first elastic member 512 and the second elastic member 522 have different lengths and different pounds so that the synchronization assembly 3 can transfer different action forces to the first passive brake cable 51 and the second passive brake cable 52.

Also, when the left-side brake lever 6 is continuously forced by the manipulator, the synchronization assembly 3 continuously presses the second elastic member 522 until the synchronization assembly 3 presses the first elastic member 512. Thus, the first elastic member 512 and the first passive limiter 511 pull the brake assembly 7 of the front wheel connected to the first passive brake cable 51 because of the movement of the synchronization assembly 3 so that the first passive brake cable 51 brakes the brake assembly 7 of the front wheel. Thus, the brake assembly 7 of the rear wheel can be firstly braked and then the brake assembly 7 of the front wheel can be braked according to the predetermined ratio between the first elastic member 512 and the second elastic member 522 so that the brake security can be achieved. Also, adjusting elements for adjusting the tightness of each of the first passive brake cable 51 and the second passive brake cable 52 may be respectively disposed in the first adjusting portion 123 and the second adjusting portion 124.

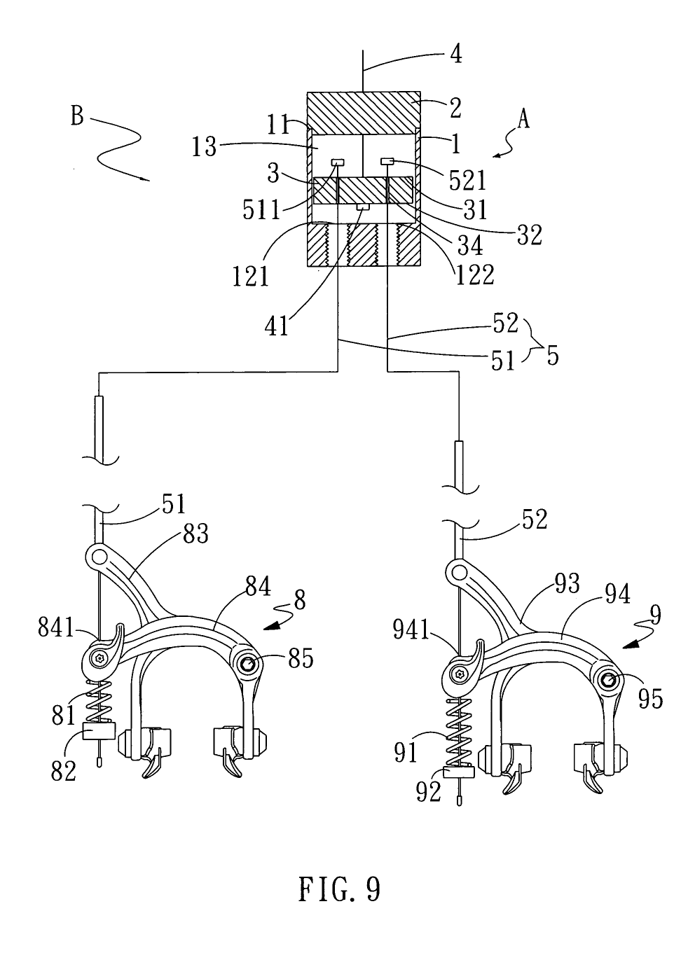

Referring to FIGS. 1 and 9, a brake system B of the invention includes a brake device A, a first brake assembly 8 and a second brake assembly 9. The brake device A mainly has a housing 1, the housing 1 has an open end 11, a closed end 12 and a chamber 13. A top lid 2 is disposed at the position of the open end 11. The top lid 2 has a first opening 21 and a second opening 22. The closed end 12 has a third opening 121 and a fourth opening 122. A synchronization assembly 3 is disposed within the chamber 13. The synchronization assembly 3 has a first end surface 31 and a second end surface 32. At least one first through hole 33 and at least one second through hole 34 are formed between the first end surface 31 and the second end surface 32. At least one active brake cable set 4 is disposed at the positions of the first through hole 33 and the first opening 21 and the second opening 22 of the top lid 2. The active brake cable set 4 penetrates through the first opening 21 and the second opening 22 of the top lid 2 and the first through hole 33. An active limiter 41 is connected to the distal end position of the active brake cable set 4 penetrating through the first through hole 33. A passive brake cable set 5 is disposed at the positions of the second through hole 34 and the third opening 121 and the fourth opening 122 of the closed end 12. The passive brake cable set 5 has a first passive brake cable 51 and a second passive brake cable 52. The first passive brake cable 51 penetrates through the third opening 121 and the second through hole 34. The distal end position of the first passive brake cable 51 penetrating through the second through hole 34 is connected to a first passive limiter 511. The second passive brake cable 52 penetrates through the fourth opening 122 and the second through hole 34. The distal end position of the second passive brake cable 52 penetrating through the second through hole 34 is connected to a second passive limiter 521.

The first passive brake cable 51 and the second passive brake cable 52 are respectively connected to the first brake assembly 8 of the front wheel and the second brake assembly 9 of the rear wheel. The first brake assembly 8 has a first elastic member 81 and a first fixture limiter 82. The first elastic member 81 and the first fixture limiter 82 are connected to the distal end of the first passive brake cable 51. Also, the first brake assembly 8 has a first fixed jaw 83, a first movable jaw 84, and a pin 85, disposed between the first fixed jaw 83 and the first movable jaw 84, for pivotally connecting the first fixed jaw 83 to the first movable jaw 84. The first movable jaw 84 has a movable arm 841, and the first passive brake cable 51 penetrates through the movable arm 841. The first fixture limiter 82 is disposed at the distal end of the first passive brake cable 51 penetrating through the movable arm 841. The first elastic member 81 is provided between the first fixture limiter 82 and the movable arm 841. Also, the second brake assembly 9 has a second elastic member 91 and a second fixture limiter 92. The second elastic member 91 and the second fixture limiter 92 are connected to the distal end of the second passive brake cable 52. The second brake assembly 9 has a second fixed jaw 93, a second movable jaw 94 and a pin 95, disposed between the second fixed jaw 93 and the second movable jaw 94, for pivotally connecting the second fixed jaw 93 and the second movable jaw 94. The second movable jaw 94 has a movable arm 941, and the second passive brake cable 52 penetrates through the movable arm 941. The second fixture limiter 92 is disposed at the distal end of the second passive brake cable 52 penetrating through the movable arm 941, and the second elastic member 91 is disposed between the second fixture limiter 92 and the movable arm 941.

The first brake assembly 8 is connected to the front wheel of the bicycle, while the second brake assembly 9 is connected to the rear wheel of the bicycle. When the first passive brake cable 51 and the second passive brake cable 52 are pulled by the left-side brake lever 6 or the right-side brake lever 6 (see FIG. 5), the movable arms 841 and 941 are concurrently pulled so that clipping operations are generated between the first fixed jaw 83 and the second fixed jaw 93 and between the first movable jaw 84 and the second movable jaw 94. At this time, the first elastic member 81 and the second elastic member 91 are respectively disposed at the distal end positions of the first passive brake cable 51 and the second passive brake cable 52 and connected to the movable arms 841 and 941 and the fixture limiters 82 and 92, respectively. The first elastic member 81 and the second elastic member 91 may have different lengths and different pounds. Thus, the first passive brake cable 51 and the second passive brake cable 52 can firstly brake the second brake assembly 9 of the rear wheel and then the first brake assembly 8 of the front wheel according to the ratio in order to enhance the brake security, to effectively reduce the size of the brake device A and to effectively decrease the manufacturing cost of the brake device A.

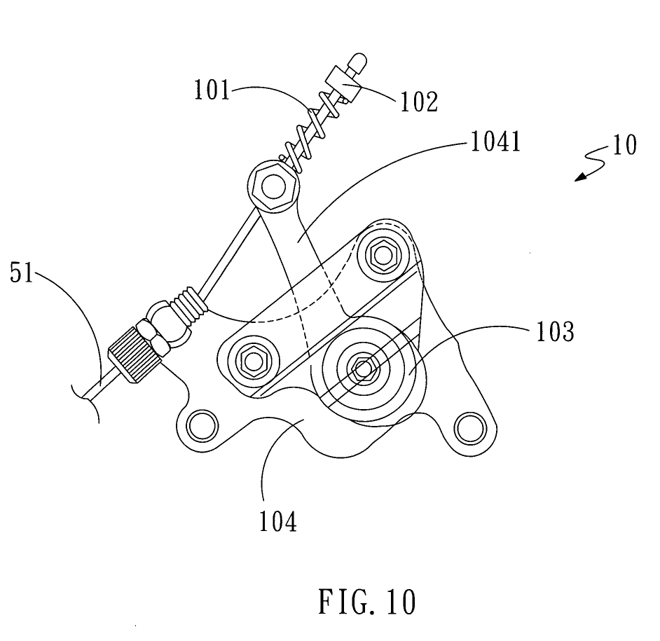

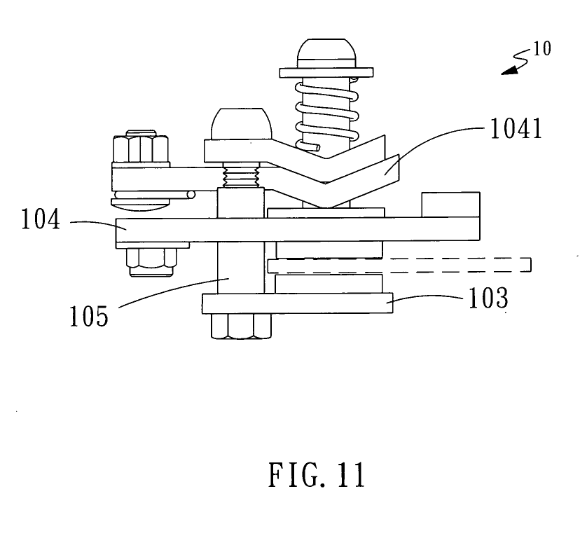

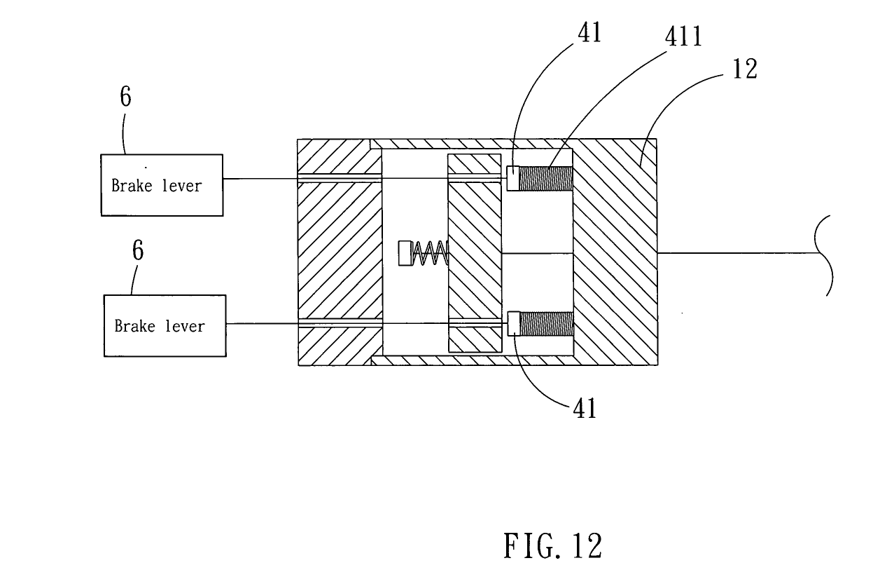

As shown in FIGS. 10 and 11, a disk-type brake assembly 10 is connected to the first passive brake cable 51 and the front wheel of the bicycle, and the disk-type brake assembly 10 has a third elastic member 101 and a third fixture limiter 102. The length and pounds of the third elastic member 101 may be selected according to the requirements. A disk-type fixed jaw 103 and a disk-type movable jaw 104 of the disk-type brake assembly 10 are pivotally connected together through a pin 105. When the first passive brake cable 51 is pulled, a movable arm 1041 is simultaneously pulled, and the clipping operation is generated between the disk-type fixed jaw 103 and the disk-type movable jaw 104. According to the ratio between the third elastic member 101 and the corresponding elastic member of the rear wheel, the rear wheel can be firstly braked and then the front wheel is braked so that the brake security can be enhanced. As shown in FIG. 12, a tensile elastic member 411 may be disposed between the active limiter 41 and the closed end 12 so that, when the left-side brake lever 6 or the right-side brake lever 6 is forced by the manipulator, the brake lever 6 on the other side can be kept in the stable state without shaking through the tensile elastic member 411.

Thus, the invention has the following advantages. First, the coefficient of security is high. Second, the structure is simple. Third, the manufacturing and assembling costs are low. Fourth, the assembled size is reduced.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A brake device, comprising:
a housing having an open end, a closed end and a chamber communicating with the open end;
a top lid having at least one opening, wherein the top lid is oppositely connected to the open end of the housing;
a synchronization assembly having a first end surface, a second end surface, and at least one first through hole and at least one second through hole formed between the first end surface and the second end surface, wherein the synchronization assembly is accommodated within the chamber;
an active brake cable set having at least one active brake cable penetrating through the first through hole; and
a passive brake cable set having a first passive brake cable and a second passive brake cable respectively penetrating through the second through hole, wherein a first elastic member and a second elastic member are respectively disposed at positions of the first end surfaces of the first passive brake cable and the second passive brake cable.

2. The brake device according to claim 1, wherein the top lid comprises a first opening and a second opening, wherein the first opening and the second opening axially penetrate through the top lid.

3. The brake device according to claim 1, wherein the closed end has a third opening and a fourth opening, and the third opening and the fourth opening axially penetrate through the closed end.

4. The brake device according to claim 3, wherein the closed end further has a first adjusting portion and a second adjusting portion, the first adjusting portion has a first internal thread hole communicating with the third opening, and the second adjusting portion has a second internal thread hole communicating with the fourth opening.

5. The brake device according to claim 1, wherein the active brake cable penetrates through the opening of the top lid and the first through hole, a distal end position of the active brake cable penetrating through the first through hole is connected to an active limiter, and the active limiter corresponds to a position of the second end surface.

6. The brake device according to claim 3, wherein the first passive brake cable of the passive brake cable set penetrates through the third opening and the second through hole, a distal end position of the first passive brake cable penetrating through the second through hole is connected to a first passive limiter, the second passive brake cable penetrates through the fourth opening and the second through hole, and a distal end position of the second passive brake cable penetrating through the second through hole is connected to a second passive limiter.

7. A brake system, comprising:
a brake device, comprising:
a housing having an open end, a closed end and a chamber communicating with the open end;
a top lid having at least one opening, wherein the top lid is oppositely connected to the open end of the housing;
a synchronization assembly having a first end surface, a second end surface, and at least one first through hole and at least one second through hole formed between the first end surface and the second end surface, wherein the synchronization assembly is accommodated within the chamber;
an active brake cable set having at least one active brake cable penetrating through the first through hole;
a passive brake cable set having a first passive brake cable and a second passive brake cable respectively penetrating through the second through hole;
a first brake assembly having a first elastic member and a first fixture limiter, which are connected to a distal end of the first passive brake cable; and
a second brake assembly having a second elastic member and a second fixture limiter, which are connected to a distal end of the second passive brake cable.

8. The brake system according to claim 7, wherein the first brake assembly has a first fixed jaw, a first movable jaw, and a pin, disposed between the first fixed jaw and the first movable jaw, for pivotally connecting the first fixed jaw to the first movable jaw, wherein the first movable jaw has a movable arm, the first passive brake cable penetrates through the movable arm, the first fixture limiter is disposed at the distal end of the first passive brake cable penetrating through the movable arm, and the first elastic member is disposed between the first fixture limiter and the movable arm.

9. The brake system according to claim 7, wherein the second brake assembly has a second fixed jaw, a second movable jaw, and a pin, disposed between the second fixed jaw and the second movable jaw, for pivotally connecting the second fixed jaw to the second movable jaw, the second movable jaw has a movable arm, the second passive brake cable penetrates through the movable arm, the second fixture limiter is disposed at the distal end of the second passive brake cable penetrating through the movable arm, and the second elastic member is disposed between the second fixture limiter and the movable arm.
